(19) United States
(12) Patent Application Publication
(10) Pub. No.: US 2015/0088028 A1
(43) Pub. Date: Mar. 26, 2015

(54) Tympanic Thermometer

(71) Applicant: Xavier LEDOUX, Sint Maarten (NL)

(72) Inventor: Xavier Ledoux, Sint Maarten (NL)

(21) Appl. No.: 14/397,252

(22) PCT Filed: Apr. 11, 2013
(86) PCT No.: PCT/FR2013/050786

§ 371 Date: Oct. 27, 2014

(30) Foreign Application Priority Data
Apr. 27, 2012 (FR) 1253960

(51) Int. Cl. G01K 1/08; G01K 13/00

(52) U.S. Cl. CPC G01K 1/086; G01K 13/002
USPC 600/549

(57) ABSTRACT

A device for the non-invasive measurement of the core temperature of a patient that includes a tympanic thermometer with a means for measuring the temperature of the patient is described. The device includes a flexible tube capable of being inserted into an external auditory meatus and including an end to which a sensor is connected; a housing including a shell to which a display for displaying the measured temperature is attached; a first blocking means for blocking the external auditory meatus; and a second blocking means for isolating the external auditory meatus from the ambient environment. According to the invention, the measuring means, the housing and the first and second blocking means are sealed and washable.

### BACKGROUND

The invention relates to a tympanic thermometer.

The present invention relates to the field of medical thermometers. In particular, it is aimed at the tympanic thermometers intended to measure the temperature of a body, for example of a human body, accurately, notably in difficult climatic conditions and environments.

It is known practice to measure the temperature of a human body, for example, at the tympanum, because it substantially agrees with the real “core” internal temperature of a body compared with the temperatures read in other, conventional bodily areas (armpit, oral cavity, etc.).

A tympanic thermometer is known for example from the document EP 0,461,068 that is designed for emergency rescues, for example, in cold, in mountains, at sea, in order to diagnose possible hypothermia. This thermometer comprises a tympanic probe provided with a foam ring and a support limiting its penetration into the external auditory meatus. A flexible cord links the probe to a housing comprising a shell equipped on its first face with means for displaying the measured temperature and with an ear insulating foam fixed onto its second face. Furthermore, a band is used to tighten the housing, covering the ear, on the head of a patient.

However, it is not possible to decontaminate and disinfect this tympanic thermometer which comprises parts made of foam in contact with bodily areas of a patient, in particular with the external auditory meatus and the auricle of the ear, which can transfer microorganisms from one patient to another, infecting them. Furthermore, the thermal insulation of the external auditory meatus from the ambient environment that this foam offers is insufficient, which can adversely affect the quality of the measurements. In practice, the foam fixed onto the shell is an open-cell foam resulting in the absorption of liquid and the penetration of micro-organisms. To this is added the fact that this thermometer is not sealed, does not withstand the fluids used in medical environments and has numerous constraints on its use.

The objective of the invention is notably to mitigate all or some of the drawbacks of the prior art.

More specifically, one object of the invention is to provide a tympanic thermometer that is easy to clean and decontaminate.

### SUMMARY

These objectives are achieved by virtue of a device for measuring the internal temperature of a patient, the device comprising a tympanic thermometer comprising:

a means for measuring the temperature of a patient consisting of a flexible tube capable of being introduced into an external auditory meatus and comprising an end to which a sensor is fixed;

a housing comprising a shell to which means for displaying the measured temperature are fixed;

a first blocking means for blocking the external auditory meatus;

a second blocking means for insulating the external auditory meatus from the ambient environment.

The invention is noteworthy in that the measurement means, the housing and the first and second blocking means are sealed and can be cleaned.

Thus, the tympanic thermometer can be cleaned, disinfected and decontaminated by means as used for example in the medical services to avoid the transfer of microorganisms such as bacteria, viruses or fungi that can infect the patients.

According to a particular embodiment, the second blocking means is a separate element from the housing of the tympanic thermometer.

This makes it possible for the measurement device to be manipulated easily and in particular for the reading of the displayed measured temperature to be easily accessible. Obviously, the separation of the two elements means that the second blocking means can easily be cleaned and decontaminated.

According to a second embodiment, the second blocking means is fixed to the housing, forming a sealed assembly. Such an arrangement will have the advantage of avoiding use of the thermometer without the second blocking means.

Advantageously, the second blocking means comprises a thermally insulating foam formed in a sealed, impermeable and removable jacket.

This means that the foam used to insulate the external auditory meatus of an ear from the ambient environment is not in contact with some of the bodily areas of the patient, or with other contaminable elements, which avoids the spread of infections. The sealed, impermeable and removable jacket is an inexpensive and reliable solution, and facilitates the replacement of the foam.

According to an important feature, the second blocking means has a covering surface area of between 400 mm² and 5000 mm².

This means that the second blocking means can be adapted to all categories of patients and makes it possible to insulate the inside of the ear but also beyond the auricle of the ear.

Provision is made for the jacket to have a height of between 10 and 70 mm so as to contain any thickness, in particular thermally insulating foams that have a great thickness for a better insulation of the external auditory meatus.

According to another embodiment, the first blocking means comprises at least a part which substantially forms an angle of between 35 and 90° with an axis, this axis being wholly or partly concentric with a wall of this part to block the external auditory meatus and limit the penetration of the tube into said meatus.

According to a preferred aspect, the tympanic thermometer and/or the second blocking means are made of polymer materials in order to withstand the hostile environments and improve the seal-tightness.

To increase the thermal insulation capability, the foam is made of a closed-cell polymer material.

Advantageously, provision is made for the measurement device to exhibit a positive buoyancy in a fluid depending on the materials and its dimensions to avoid the risk of it sinking for example, in an intervention at sea for example.

For reasons of hygiene or adaptability of the measurement means to different patients, provision is made for the measurement means to be removable.

Advantageously, the housing can comprise at least one unit for storing the measured temperature. That should allow for the different temperatures read to be tracked.

Provision is also made for the link between the housing and the measurement means to be of wireless type. This arrangement avoids the bulk of the measurement device and favors the ergonomics, handleability and convenience in data exchange.

### BRIEF DESCRIPTION OF THE DRAWINGS

Other innovative features and advantages will emerge from the following description, given by way of indication and without limitation, with reference to the attached drawings, in which:

FIG. 1 is a perspective view of a measurement device according to a first embodiment of the invention;

FIG. 2 is a side view of another embodiment of the measurement device in a situation of use on a patient;

FIG. 3 is a perspective view of another embodiment of the measurement device with the second blocking means fixed onto the housing of the tympanic thermometer;

FIG. 4 represents a perspective and front view of the measurement device according to FIG. 3;

FIG. 5 is a perspective view of a thermally insulating foam formed in a jacket;

FIG. 6 is a detailed view of an embodiment of the first blocking means according to the invention;

FIG. 7 illustrates a measurement means in the ear of a patient;

FIG. 8 illustrates another embodiment of the invention with the removable measurement means;

FIG. 9 is a block diagram of the measurement device;

FIG. 10 is a view of another embodiment of the invention;

FIG. 11 is a perspective view of another embodiment of the measurement device according to the invention; and

FIG. 12 is a side view of the measurement device according to FIG. 11.

### DETAILED DESCRIPTION

The device 1 for measuring the internal temperature of a patient according to the invention is designed for medical personnel to take a measurement of the tympanic temperature of the patient. This temperature measurement device is particularly suited to a hostile environment, such as mountains, sea, etc.

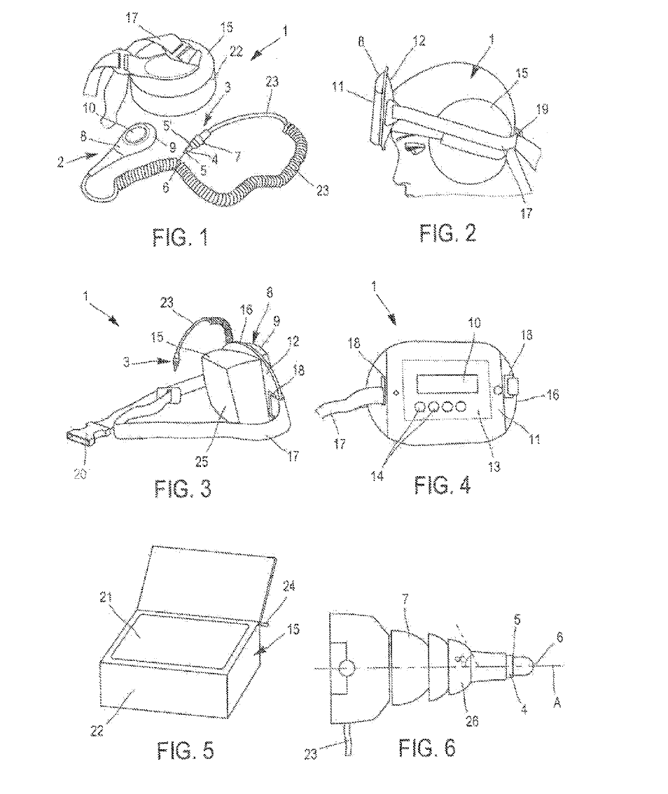

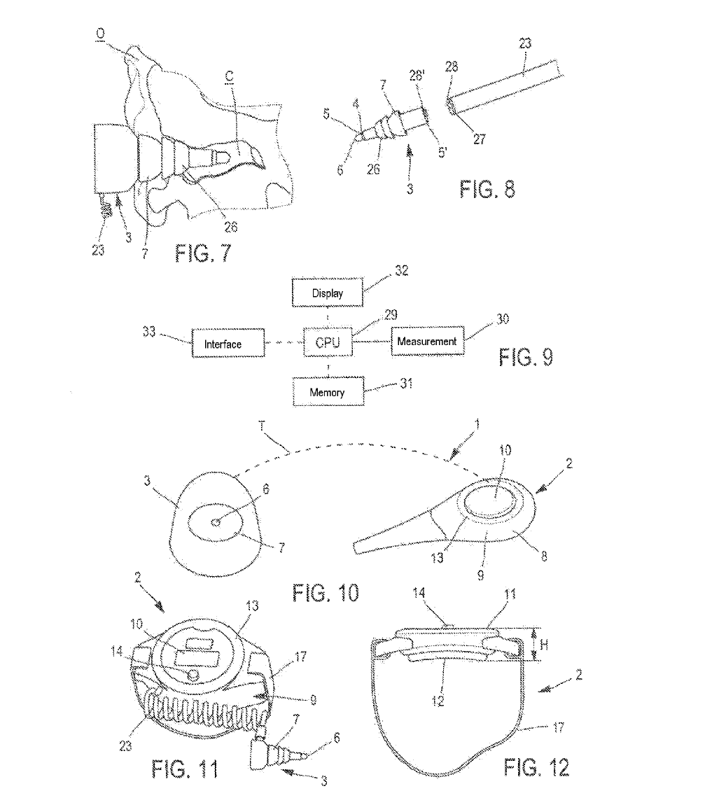

FIG. 1 illustrates, in a perspective view, an embodiment of the invention in which the device 1 for measuring the internal temperature of the patient comprises a tympanic 2 or auricular thermometer.

The tympanic thermometer 2 comprises a measurement means 3. The latter can consist of a flexible tube 4 capable of being introduced into the external auditory meatus C of the patient and comprising an end 5 to which a sensor 6 is fixed. The sensor 6, well known to those skilled in the art, is intended to pick up the heat radiated by the tympanum. A first blocking means 7, which is in contact with a bodily area of the patient, in particular with the elastic cartilage of the ear O, is mounted at the other end 5′ of the flexible tube 4. The first blocking means 7 is for blocking the external auditory meatus C of the ear O. The flexible tube 4 has a diameter of between 2 and 15 mm. It can have a length of between 4 and 20 mm.

The tympanic thermometer 2 also comprises a housing 8 provided with a shell 9 to which means 10 for displaying the temperature measured by the sensor 6 are fixed. More specifically, the display means 10 are fixed onto a front face 11 of the shell 9. The display means 10 can comprise a frame 13 supporting, for example, an LCD (Liquid Crystal Display) screen. Control or indication buttons 14 (on/off, battery readout, etc.) can be provided, for example, on the frame 13 or the shell 9 of the housing 8 (see FIGS. 4, 11 and 12). The shell 9 also has a rear face 12 in which a housing can be formed, intended to receive at least one battery (not represented). The housing will be closed by a removable cover (also not represented). The housing 8 can be linked with the measurement means 3 by a flexible cord 23. The housing 8 can have a height H of between, for example, 5 and 20 mm.

The tympanic thermometer 2 also comprises a second blocking means 15 which is in contact with a bodily area of the patient, in particular with the auricle O. The second blocking means 15 makes it possible to insulate the external auditory meatus of the ear of the patient from the ambient environment as illustrated in FIG. 2.

According to the invention, the measurement means 3, the housing 8, the first 7 and second 15 means for blocking the external auditory meatus C of the patient are sealed and can be cleaned.

In the context of the present invention, the term “sealed” should be understood to mean that no fluid is allowed to pass and that it is capable of being cleaned, disinfected, decontaminated by a disinfectant liquid solution, such as, but not limited to, the solutions used for medical devices.

As can be seen in FIGS. 1 and 2, the second blocking means 15 is a separate element from the housing 8 of the tympanic thermometer 2. Each of the separate elements is sealed.

In FIG. 3, it can be seen that the second blocking means 15 is fixed to the housing 8. In this case, the housing 8 and the second blocking means 15 form a sealed assembly. To perfect the seal-tightness and the fixing, a plate 16 can be interposed between the second blocking means 15 and the housing 8 of the tympanic thermometer 2. The fixing can be carried out by gluing, welding or another sealed element.

A strap 17 for holding the second blocking means 15 pressed onto the ear O of the patient can be provided. The strap 17 can be secured to the plate 16 which is provided with two openings 18 for this purpose (FIGS. 3 and 4). The strap 17 can also be fixed to the second insulating means 15 (FIG. 1). The strap 17 can comprise tightening loops 19 and/or closure loops 20. However, it is possible to envisage having the second blocking means 15 mounted on an arc in the configuration of an audio headset for example, or similar. Similarly, an elastic band (not represented) may be sufficient to press the second blocking means 15 onto the ear O of the patient.

As illustrated in FIG. 5, the second blocking means 15 is made of a thermally insulating foam 21 which is formed in a sealed and impermeable jacket 22. The jacket 22 can also be removable.

Advantageously, the tympanic thermometer 2 and/or the second blocking means 15 are made of polymer materials.

To make the measurement device as sealed as possible, a transparent sealing film can be provided, either mounted on the front face 11 and/or on the rear face 12 of the housing 8. The sealing film can be made of polyethylene for example. It can be fixed by gluing or welding, seal-tight fixing screws or other means.

The thermally insulating foam 21 can be made of a closed-cell polymer material. Preferably, the foam 21 is made of polyurethane. Other materials can of course be used. The thickness of the foam 21 can be between 20 and 60 mm. It also has a density of between 20 and 45 kg/m³. Through its composition and its thickness, the foam 21 allows for an excellent insulation of the external auditory meatus from the ambient environment.

The jacket 22 can be made of a flexible polymer. Preferably, the jacket 22 can be made of silicone or polyurethane. It can have a height of between 10 and 70 mm so that it matches the thickness of the insulating foam 21. The jacket 22 can be provided with a sealed closure 24 of slider type making it possible to open or close the jacket 22 in order to introduce the foam 21 therein or remove it therefrom. However, the jacket 22 can be completely closed for example by welding or gluing.

The second blocking means 15 can have any shape, circular, rectangular or other. Provision is made for the second blocking means 15 to have a covering surface area 25 of between 400 mm² and 5000 mm².

The first blocking means 7 represented in FIG. 6 can be fixed or overmolded or mounted removably on the flexible tube 4. More specifically, the first blocking means 7 comprises at least a part 26 which substantially forms an angle a of between 35 and 90° with an axis A. This axis A is wholly or partly concentric with the wall presented by the part 26 of the first blocking means 7. The wall of the part 26 can be in the form of a collar or substantially circular. Preferably, this angle a is substantially 90°. This configuration makes it possible on the one hand to block the external auditory meatus and on the other hand to limit the penetration of the measurement means 3, notably the flexible tube 4, into this duct, and limit the heat losses. Also, the sensor 6 and/or flexible tube 4 has a rounded end to avoid any risk of pain in the event of contact with the wall of the auditory meatus or with the tympanum. The first blocking means 7 can take the form of an (intra-auricular) earflap or of an earphone.

According to an advantageous feature, the measurement device 1 exhibits a positive buoyancy in a fluid depending on the material and on its dimensions. More specifically, the seal-tightness of the tympanic thermometer 2 and of the second blocking means prevents, on the one hand, any ingress of liquid. On the other hand, the material used, in this case polyurethane for the foam 21 and/or the jacket 2, is a highly buoyant material. The measurement device 1 has a weight of between 60 and 500 g, the weight of the measurement device 1 being less than the buoyancy which corresponds to the density of the fluid multiplied by the volume of the fluid. The measurement device 1 can thus float in sea or river water for example.

Provision can be made for the measurement means 3 to be removable (FIG. 7), in particular, for example, from the flexible cord 23 or from the first blocking means 7. The flexible tube 4 can be disconnected at its other end 5′ (situated before or after the first blocking means 7) from the flexile cord 23 or from the first blocking means 7. The flexible cord 23 can comprise, at one of its ends 27, a female-type connection plug 28 making it possible to connect the second end 5′ of the flexible tube 4 comprising a male connection plug 28′ for example. Obviously, any type of connection means can be considered. This configuration makes it possible for the measurement means 3 to be unique and disposable, or makes it possible for the measurement means 3 to be interchangeable for the latter to be adapted to different patients, such as new-born babies, children and adults.

According to a feature that can be envisaged (see FIG. 10), the link between the housing 8 and the measurement means 3 is of wireless type. The housing 8 and the measurement means can each be equipped with a transmitter and a receiver (not represented) to ensure the transmission T of the information from the housing 8 or from the measurement means 3. The wireless link can use Wi-Fi, infrared, and other such systems. Preferably, the wireless system uses the Bluetooth® configuration according to the well-known standards IEEE 802.15.1 to IEEE 802.15.4. The housing 8 can also communicate wirelessly with other terminals containing a medical file of the patient for example.

According to another feature that can be envisaged, the housing 8 can comprise at least one unit 31 for storing the measured temperature. In FIG. 9 representing a block diagram of the measurement device 1, the latter can comprise a CPU processing unit 29. This processing unit 29 is connected to a temperature measurement unit 30, a storage unit 31 for storing the measurements read and other program data, a unit 32 for displaying the information processed by the processing unit 29 and a communication interface unit 33. The storage unit 31 is intended to receive data in analog and/or digital format. Preferably, the storage unit 31 can comprise an electronic integrated circuit mounted on a printed circuit which is housed in the housing of the tympanic thermometer 2. The memory can be of RAM and/or ROM and/or EPROM type.

The measurement device I is used as follows: a user introduces the measurement means 3 comprising the flexible tube 4 and the sensor 6 into the external auditory meatus C of the ear O of the patient or of the accident victim. The first blocking means 7 blocks the external auditory meatus by means of a part 26 of this first blocking means 7 which abuts with the entry of the auditory meatus for a first insulation. The user presses the second insulation means 15 onto the auricle so as to hold, on the one hand, the measurement means 3 inside the auditory meatus, and, on the other hand, totally insulate said meatus from the ambient environment. A small volume of air located inside the meatus then reaches the temperature of the blood in the internal carotid artery. The user can then view the temperature by virtue of the display means 10. The user can then grip the head of the patient on which the second blocking means 15 is placed. The user can keep the housing 8 between the hands or position it on the head of the patient by means of the strap 17. The thermometer does not need to be calibrated. Reliable measurements concerning the core temperature of the patient can thus be obtained, non-invasively.

1.-13. (canceled)

14. A device for measuring the internal temperature of a patient, the device comprising a tympanic thermometer comprising:
a flexible tube for measuring the temperature of the patient and configured to be introduced into an external auditory meatus and comprising an end to which a sensor is fixed;
a housing comprising a shell to which a display for displaying the measured temperature is fixed;
a first blocker for blocking the external auditory meatus;
a second blocker for insulating the external auditory meatus from the ambient environment, wherein the flexible tube, the housing and the first and second blocker are sealed and can be cleaned.

15. The device of claim 14, wherein the second blocker is a separate element from the housing of the tympanic thermometer.

16. The device of claim 14, wherein the second blocker is fixed to the housing, forming a sealed assembly.

17. The device of claim 15, wherein the second blocker comprises a thermally insulating foam formed in a sealed, impermeable and removable jacket.

18. The device of claim 17, wherein the second blocker has a covering surface area of between about 400 mm² and about 4400 mm².

19. The device of claim 17, wherein the jacket has a height between about 10 and about 70 mm.

20. The device of claim 14, wherein the first blocker comprises at least a part which substantially forms an angle (a) of between about 35° and about 90° with an axis (A) being wholly or partly concentric with a wall of the part.

21. The device of claim 14, wherein the tympanic thermometer and/or the second blocker are made of polymer materials.

22. The device of claim 17, wherein the foam is made of a closed-cell polymer material.

23. The device of claim 14, wherein the device exhibits a positive buoyancy in a fluid.

24. The device of claim 14, wherein the flexible tube is removable.

25. The device of claim 14, wherein the housing comprises at least one unit for storing the measured temperature.

26. The device of claim 14, wherein a link between the housing and the flexible tube is wireless.

27. A device for measuring the internal temperature of a patient, the device comprising a tympanic thermometer comprising:
a means for measuring the temperature of the patient that includes a flexible tube configured to be introduced into an external auditory meatus and comprising an end to which a sensor is fixed;
a housing comprising a shell to which means for displaying the measured temperature are fixed;
a first blocking means for blocking the external auditory meatus;
a second blocking means for insulating the external auditory meatus form the ambient environment, characterized in that the measurement means, the housing and the first and second blocking means are sealed and can be cleaned.
